(19) United States
(12) Patent Application Publication
(10) Pub. No.: US 2011/0025156 A1
(43) Pub. Date: Feb. 3, 2011

(54) MACHINE FOR FIXING

(75) Inventors: Ingolf Groening, Lohr a. M. (DE); Ralf Kruse, Wurzburg (DE)

Correspondence Address: BACHMAN & LAPOINTE, P.C., 900 CHAPEL STREET, SUITE 1201, NEW HAVEN, CT, 06510, US

(73) Assignee: WITTENSTEIN AG, Igersheim (DE)

(21) Appl. No.: 12/848,492

(22) Filed: Aug. 2, 2010

(30) Foreign Application Priority Data
Aug. 3, 2009 (DE) 102009035894.3

(51) Int. Cl. H02K 49/10; H02P 15/00

(52) U.S. Cl. 310/93; 307/104

(57) ABSTRACT

Machine for contactless fixing of a movement degree of freedom, having a primary part and a secondary part, wherein the primary part and the secondary part are designed such that a cogging force when no current is flowing in the machine is at least 50% of the maximum force of the machine.

### BACKGROUND OF THE INVENTION

The invention relates to an electrical machine for contactless braking and to a drive having a machine such as this and to a method.

Brakes based on the principle of friction locking are primarily used for braking or holding shafts in electrical machines. One problem with brakes such as these is that they are subject to wear.

It is known from DE 102 20 687 A1 for the cogging torque of an electrical machine to be used in conjunction with a gearbox that is connected to be used to ensure that the electrical machine is stationary when no current is flowing through the electrical machine. This machine makes use of the fact that the electrical machine is connected to a gearbox in such way that friction losses in the gearbox are additionally used to ensure that the machine is stationary. This design is complicated, and cannot be used in all applications.

The object of the invention is to overcome the abovementioned disadvantages of the prior art, and one particular object of the invention is to specify a fixing brake which is subject to less wear, or no wear at all.

### SUMMARY OF THE INVENTION

A machine is provided in order to achieve the object. This machine offers the advantage that it produces a high cogging force without wear and contactlessly. “fogging force” and “machine” should in this case be understood in a general form, such that the term machine in particular includes electrical machines which operate rotationally or translationally. The cogging force therefore also includes the term cogging torque. The machine makes it possible to achieve a braking effect even in difficult environmental conditions, for example in oil; in general, use is possible in a wide range of environmental conditions. In general, the brake comprises a fixed-position part, preferably the primary part, and a moving part, preferably the secondary part, wherein the primary part is a stator and the secondary part is a rotor or, in the case of a linear machine, a translator. The parts are arranged and designed such that the reluctance effect produces as high a cogging force as possible. The cogging force is preferably at least 50% of the maximum force of the electrical machine, with the maximum force being defined as the maximum force which can be produced by the machine if it were to be used as a drive. Even more preferably, the cogging force is at least 70 or 80%, and even more preferably at least 90%, of the maximum force. In the case of a rotating machine, the maximum force is the maximum torque during rotation. In this case, in some circumstances, it is accepted that the torque ripple can be high in order to exploit the advantages of the invention.

The secondary part preferably has at least one permanent magnet. It is particularly preferable to use a plurality of permanent magnets, which are arranged alternately. In conjunction with teeth on a stator, this makes it possible to form cogging locations with high cogging forces at periodically recurring positions. Embodiments are particularly preferable in which at least one permanent magnet is additionally provided on the primary part, in order to further increase the cogging force. A short-circuiting circuit, which can be activated when no current is flowing, offers an additional brake against inadvertent movement of the machine. A short-circuiting circuit such as this is provided in order to short-circuit an electromagnet in the machine, which is preferably arranged on the primary part. Although the short-circuiting braking torque or the short-circuiting braking force acts only during movement along the degree of freedom of the machine, this makes it possible to cope with force or torque surges so as to largely prevent temporary rotary movement or translational movement. In this case, in the case of a rotating machine, a movement degree of freedom means the rotation of the shaft of the machine and, in the case of a linear machine, it means the linear movement of the translator with respect to the stator.

One slot pitch of the primary part is advantageously identical to one pole pitch of the secondary part. This offers the advantage that the individual contributions of the individual teeth are added to one another. The slot pitch of the primary part in this case preferably corresponds to the distance or the angle between two coil cores. In a corresponding manner, the pole pitch preferably corresponds to the angular separation or translational separation between two poles, or the center planes, of permanent magnets. However, the term slot pitch can in general also be used to refer to a distance between permanent magnets or, conversely, the term pole pitch can be used to refer to the distance between electromagnets. In this case, distance preferably means the distance between the respective centers of the parts.

The width of one tooth at its head, that is to say the tooth width, of at least one tooth on the primary part is advantageously at least 20%, more preferably at least 30%, of the slot pitch of the primary part. In this case, in the case of a rotating machine, one angle width of the tooth preferably corresponds to the tooth width at the air gap between the primary part and the secondary part. It is furthermore preferable for the tooth width of at least one tooth on the primary part to correspond at most to 80% of the slot pitch of the primary part, more preferably at most 65%, and even more preferably at most 55%. Furthermore, it is preferable for one tooth width of at least one tooth on the primary part to correspond to at least 80%, more preferably 90% or 95%, of one magnet width of the primary part. In this case, the magnet width is the width of the coil winding or of the coil windings between two teeth. The tooth width of at least one tooth on the primary part preferably corresponds to at most 120%, more preferably 110% or 105%, of one magnet width in the primary part. It should be noted that, in the case of all the relative details in this paragraph which relate to a tooth, this in each case expressly discloses the idea that at least half of all the teeth on the primary part or all the teeth on the primary part are correspondingly designed. In general, the stated features offer the advantage that the cogging force is increased.

The machine advantageously has at least one control unit which is designed to pass current through an electromagnet in the machine such that the cogging force is reduced. Deliberately passing current through at least one electromagnet, or preferably at least half the electromagnets, in the primary part makes it possible to ensure that the cogging force is reduced. The current flow is preferably varied periodically. The current required for compensation is in this case calculated from the contour integral of the field strength divided by the number of turns. The current is preferably fed in in antiphase. This results in a maximum reduction in the cogging force. The period duration is preferably chosen as a function of the rotation speed of the machine. The amplitude profile of the current is expediently determined as a function of a force profile during movement when no current is flowing. In this case, the shaft, the translator or the rotor, or in general the secondary part, is moved, and the force profile is measured when no current is flowing. It is likewise possible to determine the force profile when no current is flowing by calculation. This force profile is evaluated in order to apply the current, appropriately in antiphase, to the coil or to the coil ends. The current advantageously flows so as to at least largely compensate for the cogging force. In this case, largely means compensation of at least 50%, more preferably 70% or 80%. This offers the advantage that the machine can be run sufficiently smoothly, despite the high cogging force. The machine preferably has a control unit which is designed to allow one of the preferred current flows mentioned above through the electromagnet.

It should be noted that a method according to the other independent method claim and a use according to the other independent use claim are independent subjects of the invention.

Preferably, for the purposes of a method according to the invention, in response to a fixing request, at least one electromagnet, or all electromagnets, in the machine are switched, with no current flowing, in order to build up a cogging force. It is furthermore preferable for at least one coil of an electromagnet to be short-circuited in order to achieve the abovementioned advantages. In response to a release request, current can be passed through the electromagnet. It should be noted that the expression electromagnet preferably means coils of the primary part, in which the case the winding arrangement on the primary part, which forms the coils, is preferably designed to comprise at least one phase. A three-phase winding arrangement is likewise preferred. A converter is preferably used to feed the winding or the electromagnet, or the electromagnets, in which case a current that is fed in is preferably sinusoidal, to a first approximation. Although this does not guarantee with any certainty that the cogging force is completely compensated for, it does, however, allow a reduction, thus ensuring running which is sufficiently disturbance-free in general.

A further subject matter of the invention is a drive having an electrical drive machine and a machine in one of the preferred embodiments described above, or having the preferred features described above. In this case, the machine allows selective contactless fixing of the drive machine. This means that the driven degree of freedom, that is to say for example the rotation or the translation, can be fixed with the cogging force. Preferred embodiments are, for example, a rotating drive machine, in which a rotor can be mounted on a shaft, which rotor interacts with two stators, with a first of the stators being used for drive purposes, and a second of the stators being used as a brake in the sense of a machine as described here. The drive winding or the drive windings and the braking winding or the braking windings can likewise be arranged on a stator, in order to save space. Furthermore, it is also possible to design the drive machine and the machine to be completely separate and, for example, to be connected via a gearbox, or else to be connected simply via a shaft.

In general, the use of a machine as disclosed here, for selective fixing of a drive machine, in particular of an electrical drive machine, is an independent aspect of this invention.

### BRIEF DESCRIPTION OF THE DRAWINGS

FIG. 1 shows, schematically, a detail of a machine according to the invention;

FIG. 2 shows various torque profiles which can be achieved using the machine according to the invention as shown in FIG. 1; and

FIG. 3 shows, schematically, the use of an electrical machine according to the invention, corresponding to FIG. 1.

### DETAILED DESCRIPTION

FIG. 1 shows a 60° detail of a complete machine circumference of a machine according to the invention. The other 300° correspond to a repeated arrangement of the illustrated 60°. The electrical machine 1 is a rotating machine which has an external primary part 2 and an internal secondary part 3. The primary part 2 forms a fixed-position stator, and the secondary part 3 forms a rotor. The movement degree of freedom of the electrical machine 1 is the rotation of the secondary part 3 within the primary part 2. The primary part 2 has a laminated core which forms teeth 4, with coils 5 being wound around each of the teeth 4 such that the teeth 4 together with the coils 5 form electromagnets. On its radially external side, the rotor has permanent magnets 6 and 7, wherein the permanent magnet 6 forms a rotor south pole, and the permanent magnet 7 forms a rotor north pole. There is an air gap 8 between the primary part 2 and the secondary part 3. A magnetic field is formed across the air gap 8 and the teeth 4 between the permanent magnets 6 and 7 and, when no current is flowing through the coils 5, forms a cogging force, in this case specifically a cogging torque, which counteracts rotary movement of the secondary part 3 with respect to the primary part 2. A current can be passed through the coil 5 in order to reduce the magnetic field which forms the cogging force, as a result of which the brake formed by the machine 1 is released. During rotation of the secondary part 3, current is passed through the coils 5 such that the current in the coils 5 is varied over time and over the rotation angle of the secondary part 3, to a first approximation, sinuoisally, in synchronism with the rotation of the secondary part 3, in order to reduce the cogging force. In general, the term “connecting” corresponds to switching the coil of the electromagnet to “on” and “disconnecting” corresponds to a switch off with no current flowing through the coil. However, a physical disconnection is not obligatory for “disconnecting”, e.g. also a switch working electronically can be used for “disconnecting”.

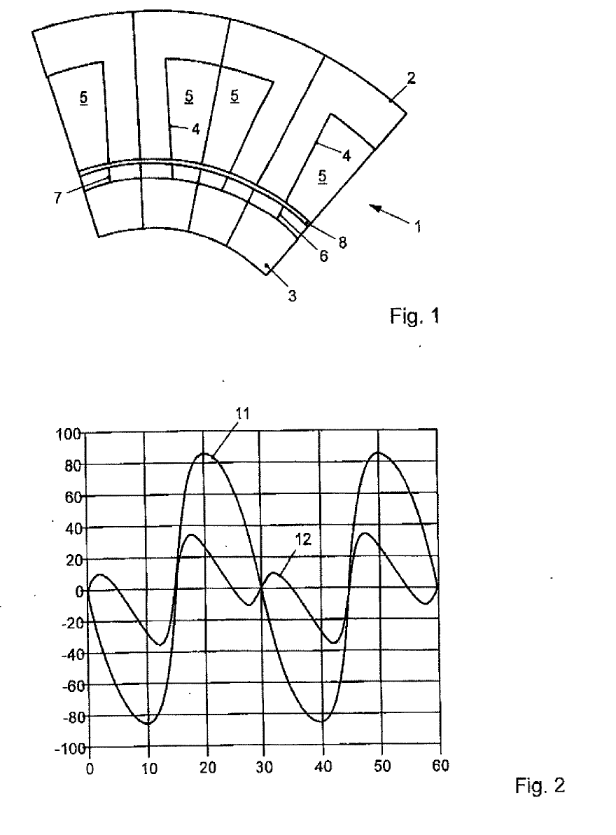

FIG. 2, which will be explained in conjunction with FIG. 1, shows the result of a state in which no current is flowing and a state in which current is flowing. The curve 11 corresponds to the cogging torque when no current is flowing. In this case, a cogging torque is indicated on the vertical axis as a percentage of the maximum torque of the machine. At the peaks of the cogging torque, the cogging torque is more than 80% of the maximum torque of the machine. In this case, the cogging torque 11 is plotted over the rotation angle in degrees of the secondary part 3 or of the rotor of the electrical machine 1. The remaining cogging force 12 is likewise plotted in FIG. 2, and corresponds to a braking torque when the current in the coils 5 is switched on. The remaining cogging torque 12 is less than 40% of the maximum torque at each rotation angle, meaning that the current flow reduces the cogging torque by more than 50%. A tooth width of the air gap which corresponds essentially to the magnet width or the width of the coil 5 was chosen in order to achieve the relatively high cogging torque. “Essentially” in this case means a ratio within the range of normal manufacturing tolerances. Furthermore, the tooth width is essentially 50% of the pole pitch, which is equal to the slot pitch. In this case, it should be noted that the slot pitch and the pole pitch are angles, with the compared lengths being the respective developments of the angles covered at the air gap 8. A further measure which in general contributes to increasing the cogging torque is to increase the axial length of the teeth.

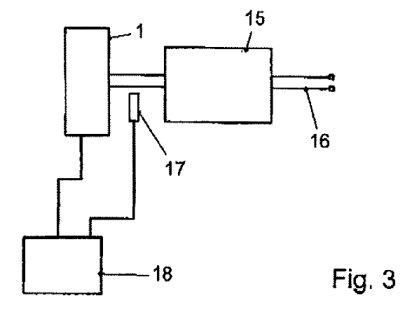

FIG. 3 shows the use of the electrical machine 1 as a brake for a drive machine 15. The drive machine 15 has an output-drive shaft 16, to which the secondary part 3 (see FIG. 1) of the electrical machine is connected. During drive operation of the drive machine 15, a sensor 17 monitors the angular position of the output-drive shaft 16. The signal from the sensor 17 is made available to a control device 18, which applies current to the coils of the electrical machine 1 such that the cogging torque of the electrical machine 1 is reduced. In response to a fixing request or braking request, the control device 18 interrupts the current flow through the coils of the electrical machine 1, thus increasing the cogging torque. Finally, the control device 18 is also designed to short-circuit one or more of the coils 5 in the electrical machine 1, in order to increase the resistance to rotation of the shaft 16 when a fixing request is made.

What is claimed is:

1. Machine, in particular an electrical machine, for contactless braking of a movement degree of freedom, comprising a primary part and a secondary part, wherein the primary part and the secondary part are designed such that a cogging force when no current is flowing in the machine is at least 50% of the maximum force of the machine.

2. Machine according to claim 1, wherein the secondary part and/or the primary part have/has at least one permanent magnet.

3. Machine according to claim 1, wherein a short-circuiting circuit, which can be activated when no current is flowing, is provided in order to short-circuit an electromagnet in the machine.

4. Machine according to claim 1, wherein a slot pitch of the primary part is identical to a pole pitch of the secondary part.

5. Machine according to claim 1, wherein a tooth width of at least one tooth on the primary part corresponds to at least 20% and at most 80% of a slot pitch of the primary part.

6. Machine according to claim 1, wherein one tooth width of at least one tooth on the primary part corresponds to at least 80% and at most 120% of one magnet width in the primary part.

7. Machine according to claim 1, wherein a control unit is designed to pass current through an electromagnet in the machine for reducing the cogging force.

8. Machine according to claim 7, wherein the control unit is designed to pass current essentially sinusoidally through the electromagnet.

9. Drive having an electrical drive machine and a machine for selective contactless fixing of the drive machine, the machine comprising a primary part, and a secondary part, wherein the primary part and the secondary part are designed such that a cogging force when no current is flowing in the machine is at least 50% of the maximum force of the machine.

10. Method for contactless selective fixing of a movement degree of freedom of a machine having a primary part, and a secondary part, wherein the primary part and the secondary part are designed such that a cogging force when no current is flowing in the machine is at least 50% of the maximum force of the machine, the method comprising the following steps:
in response to a fixing request, disconnecting an electromagnet in the machine, with no current flowing, in order to build up a cogging force for fixing the machine, and
in response to a release request, connecting and passing current through the electromagnet in order to minimize a cogging force, in order to release the machine.

11. Method according to claim 10, wherein the current flow is varied periodically after connecting the electromagnet.

12. Method according to claim 11, wherein the period duration is chosen as a function of the rotation speed of the machine.

13. Method according to claim 11, wherein the amplitude profile of the current is determined as a function of a force profile during movement when no current is flowing.

14. Method according to claim 10, wherein the current flow is used to at least largely compensate for the cogging force.
